(19) United States
(12) Patent Application Publication
(10) Pub. No.: US 2009/0085235 A1
(43) Pub. Date: Apr. 2, 2009

(54) METHOD AND APPARATUS FOR MAKING A MICROSTRUCTURED OR NANOSTRUCTURED ARTICLE

(76) Inventors: Erwin BURKLE, Benediktbeuern (DE); Steffen Burr, Bretzfeld (DE); Martin Eichlseder, Tettenweis (DE); Bernd Klotz, Grunding/Bergkirchen (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 11/277,527

(22) Filed: Mar. 27, 2006

(30) Foreign Application Priority Data
Mar. 26, 2005 (DE) 10 2005 013 974.4

(51) Int. Cl. B29C 45/00

(52) U.S. Cl. 264/1.24; 425/542; 425/575; 425/451.9; 264/1.7; 425/130

(57) ABSTRACT

In a method and apparatus for making an article with a microstructure or nanostructure, an injection molding process or an injection-compression molding process is used to produce a substrate and to apply a microstructure or nanostructure upon a surface of the substrate. Subsequently, the substrate is inundated with a cross-linking, curing material.

### CROSS-REFERENCES TO RELATED APPLICATIONS

This application claims the priority of German Patent Application, Serial No. 10 2005 013 974.4-16, filed Mar. 26, 2005, pursuant to 35 U.S.C. 119(a)-(d), the content of which is incorporated herein by reference.

### BACKGROUND OF THE INVENTION

The present invention relates to a method and apparatus for making articles having a microstructure or nanostructure, in particular a microstructure or nanostructure on a surface of the article.

Nothing in the following discussion of the state of the art is to be construed as an admission of prior art.

Plastic materials having a surface formed with a microstructure or nanostructure are used to impart certain physical effects, e.g. the lotus effect, resulting in a less soiled or self-cleaning surface and realized by applying the surface with a nanostructure. Reflection of optical articles can also be reduced by applying a microstructure or nanostructure on the surface. Microstructured or nanostructured elements can be made through an injection molding process which requires however a particular configuration of mold cavities and process conditions. Microstructures may be made through removal of microscopic material or laser application. Other methods include LIGA-technique (lithographic galvanic process) and special PVD-process (Physical Vapor Deposition). Such small structures can also be reproduced on thermoplastic material, and hot compression-molded, structured films may also be produced through back injection.

Fabrication of such products which are made of thermoplastic materials encounter a problem because they are not stable enough during use. In particular, these thermoplastic products are not sufficiently scratch-resistant. For example, in case of a fully transparent covering pane for a dashboard of a vehicle, reflection should be reduced as far as possible. This can be realized by providing the back and front sides of the pane with a nanostructure. While the backside faces the panel instruments and is separated from the surroundings so as to be inaccessible and thus not prone to soil or scratch, the front side is exposed to the vehicle interior space and thus can become dirty or scratched.

It would therefore be desirable and advantageous to provide an improved method and apparatus for making a product with a microstructure or nanostructure, to obviate prior art shortcomings and to remain useful over an extended period.

### SUMMARY OF THE INVENTION

According to one aspect of the present invention, a method of making a product with a microstructure or nanostructure includes the steps of using an injection molding process or an injection-compression molding process to produce a substrate with a microstructure or nanostructure applied upon a surface of the substrate, and inundating the substrate with a cross-linking, curing material.

According to another feature of the present invention, the substrate may be placed in a cavity of a mold, and forming a cavity gap on the surface to be inundated, when the mold is closed, wherein the inundating step includes the step of filling the cavity gap with the cross-linking material.

The present invention resolves prior art problems by inundating a substrate in a cavity with a cross-linking material to thereby form a thin top layer. The material to inundate the substrate is hereby selected to satisfy, after cross-linkage and curing, the demanded requirements such as scratch resistance and long-term stability. The microstructure or nanostructure may also be provided on the material being inundated, i.e. substrate. This structure may however also be applied upon the surface of the cross-linking materials during the inundating process.

In order to enable the microstructure or nanostructure between the substrate and the top layer to impart an effective antireflection effect, the selected materials for the substrate and the top layer may have a different refractive index after being cured.

According to another feature of the present invention, the cross-linking material may be selected from the group consisting of polyurethane material, clear lacquer material, e.g. UV curable clear lacquer, acrylic paint, and epoxy resin. The material is of low viscosity when being introduced in order to assure a complete filling of the thin cavity gap. When cured, the product has a hard top layer which in particular is optically transparent to enable a long-term use of the product. Although the afore-described materials are currently preferred, any other material that is low in viscosity is conceivable so long as the material is able to cure and especially result in an optically transparent form.

The substrate may typically be made by an injection molding process or injection compression molding process in order to provide one or more sides of the substrate with a microstructure or nanostructure. In the event the microstructure or nanostructure should not be applied onto the substrate as such but merely upon the top layer, a respective cavity surface in configured with the desired microstructure or nanostructure which is duplicated upon the surface of the top layer as the material is introduced into the cavity gap. Of course, the substrate surface as well as the top layer may be provided with a microstructure or nanostructure. It is even possible to inundate various areas of the substrate on or to repeatedly inundate the substrate in order to develop multiple layers. In addition, it is also conceivable to inundate various sides of the substrate with cross-linking material so that, e.g., both sides of the substrate can be made scratch-resistant and useful for long-term application.

According to another feature of the present invention, the substrate may be made in another cavity though injection of plastic material before undergoing the inundating step with the cross-linking top coating material in the respective cavity. As an alternative, it is also conceivable to fabricate the substrate outside a cavity before undergoing the inundating process with the coating material. Suitably, a surface of the cavity or cavities may be heated and/or cooled by a heating and/or cooling device may be provided for.

According to another aspect of the present invention, an apparatus for making an article with a microstructure or nanostructure includes a mold having a cavity for positioning a substrate, wherein the mold is constructed to form a cavity gap on at least one side of the substrate and has a cavity surface which is provided with a microstructure or nanostructure, and a feeding device for introducing into the cavity gap a cross-linking material of low viscosity before curing to thereby allow formation of a top layer with reproduction of the microstructure or nanostructure.

By providing a cavity gap between the substrate and the cavity surface, the top layer is provided with a precisely defined layer thickness, when the coating material is filled into the cavity gap, whereby the application of a respective microstructure or nanostructure is easily possible on the top layer.

According to another feature of the present invention, an injection device may be provided for introducing plastic material into the cavity of the mold for producing the substrate. As an alternative, the substrate may be made in a separate mold whose cavity is filled with plastic material from an injection device. Suitably, the molds, the feeding device, and the injection device are disposed such that the introduction of the curing coating material and the introduction of the plastic material are executed in a same cycle.

According to another feature of the present invention, the mold may be arranged in a clamping unit, e.g. a swivel platen clamping unit, sliding table clamping unit, or rotary table clamping unit.

According to another feature of the present invention, the mold may be accommodated in a clamping unit such that after formation of the substrate the mold cavity can be expanded for realizing the cavity gap for subsequently inundating the substrate with the cross-linking material.

According to another feature of the present invention, a heating unit may be provided for heating the cavity surface.

According to another feature of the present invention, the injection molding and injection compression molding processes may be combined with a polyurethane reaction injection molding (PUR-RIM) process.

According to another feature of the present invention, a heating unit may be provided for heating the mold or at least a cavity surface. In this way, the accuracy of the reproduction of the microstructure and nanostructure is enhanced, the free flow property in particular with respect to longer flow paths is improved, and the cross-linkage reaction is promoted. This would also enable execution of a hot compression molding process in an injection mold. Heating may be provided during production of the substrate as well as during inundation of the substrate. Of course, a cooling system may also be provided to ensure, for example, a more rapid expulsion of the product. Such a cooling system may be integrated in a mold, e.g. in the form of cooling channels.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a is a schematic sectional view of one embodiment of a mold being closed and filled with substrate material;

FIG. 1b is a schematic sectional view of the mold slightly opened and filled with coating material to inundate a substrate surface;

FIG. 2a is a schematic sectional view of another embodiment of a mold filled with substrate material; and

FIG. 2b is a schematic sectional view of the mold of FIG. 2a in a slightly opened state.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

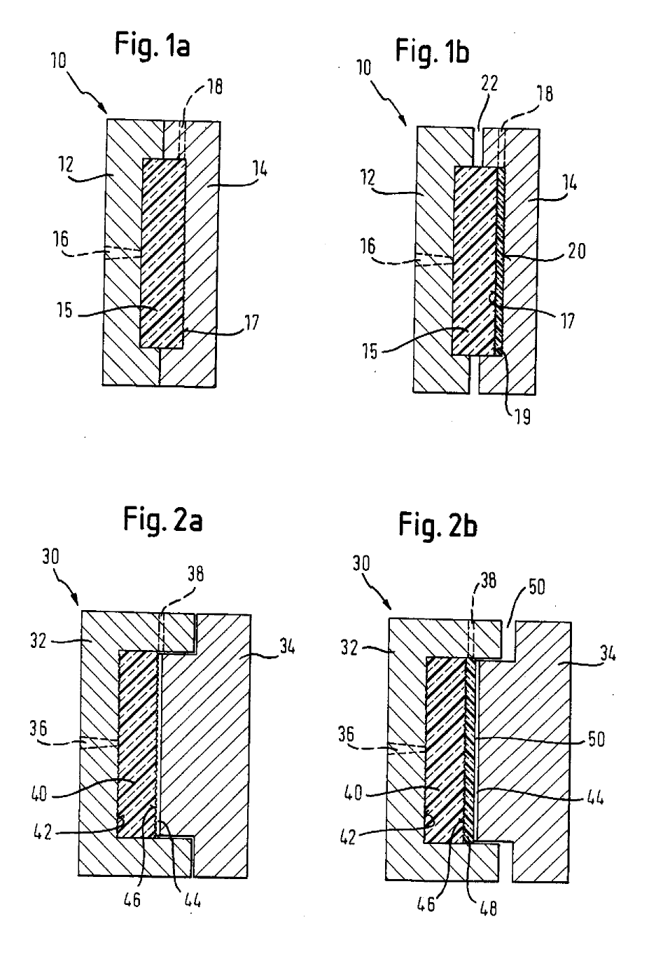

Turning now to the drawing, and in particular to FIG. 1a, there is shown a schematic sectional view of one embodiment of a mold, generally designated by reference numeral 10 for carrying out a process for making a substrate 15 and providing the substrate 15 with a microstructure and nanostructure in accordance with the present invention. The mold 10 is part of a plastics processing machine, such as an injection molding machine or injection compression molding machine which further includes much mechanical apparatus which does not appear in the drawing, e.g. a clamping unit, injection unit, PUR-unit, etc. Operation and structure of these components like many other necessary components are generally known and thus have been omitted from the Figures for the sake of simplicity. Typically, the mold 10 is integrated in a clamping unit of the plastics processing machine which also includes a plasticizing unit for a thermoplastic material as well as a PUR-RIM unit for inundating the substrate.

The mold 10 has two half-molds 12, 14 which jointly define a cavity, when the mold 10 is closed, as shown in FIG. 1a. The half-mold 12 includes an injection channel 16 via which thermoplastic melt may be introduced from an unillustrated plasticizing unit into the cavity between the half-mold 12, 14. The half-mold 14 is further provided with a feed channel 18 for introduction of a coating material, e.g. polyurethane material, to inundate the substrate 15 produced in the mold 10 (FIG. 1a). The feed channel 18 is connected with an unillustrated mixing head for supply of the coating material.

As indicated by reference numeral 17, an inside surface of the half-mold 14 is constructed with a microstructure or nanostructure.

The mode of operation is as follows: In a first process step, as shown in FIG. 1a, substrate material is introduced via injection channel 16 into the cavity of the mold 10 which is closed. The substrate material fills the cavity to form the substrate 15, whereby the microstructure or nanostructure 17 on the mold surface of the half-mold 14 is forced into and thereby reproduced on the surface of the substrate 15. After the substrate material is allowed to cure, the (right) half-mold 14 is allowed to slightly open up in a second process step, as indicated by reference numeral 22, so as to realize a disengagement or demolding between the substrate 15 and the confronting mold surface of the half-mold 14. As a result, a thin cavity gap 20 is defined adjacent to the (right) side of the substrate 15 in substantial prolongation of the feed channel 18, as shown in FIG. 1b. Coating material, e.g. polyurethane material of low viscosity can thus be introduced or poured via the feed channel 18 to completely fill the cavity gap 20. As the inside mold surface of the half-mold 14 is constructed with the microstructure or nanostructure 17, the top layer formed in the cavity gap 20 is also formed with a microstructure or nanostructure.

As a consequence of the microstructure or nanostructure 17 on the top layer, the finished product exhibits an antireflection effect. Of course, the substrate 15 as well as the introduced coating material must exhibit optically transparent characteristics. Suitably, in order to render the microstructure or nanostructure 17 between the substrate 15 and the top layer effective, the substrate material and the coating material for the top layer should have different refractive index.

Referring now to FIG. 2a, there is shown a schematic sectional view of another embodiment of a mold, generally designated by reference numeral 30 for carrying out a process for making a substrate 40 and providing the substrate 40 with a microstructure and nanostructure in accordance with the present invention. The description below will center on the differences between the embodiments of the mold 10 and 30. In this embodiment, the mold 30 has two half-molds 32, 34 constructed to form a positive mold. When the mold 30 is fully closed, as shown in FIG. 2a, a cavity is defined which receives thermoplastic material via a sprue 36 and has opposite cavity surfaces 42, 46 which are both constructed with a microstructure or nanostructure. As a result, the substrate 40 has two sides whose surface is formed with the microstructure or nanostructure. The half-mold 32 is further provided with a feed channel 38 for introduction of a coating material, e.g. polyurethane material, to inundate the substrate 40 produced in the mold 30 (FIG. 2a). The feed channel 38 is connected with an unillustrated mixing head for supply of the coating material.

The mold 30 is further provided with a heating unit 44 in close proximity of the cavity surface 46 of the half-mold 34. The heating unit 44 may be realized, e.g., by means of an electrically conductive ceramic or by means of a heating coil immediately adjacent to the cavity surface 46. Of course, a corresponding heating unit, although not shown here, may be arranged in analogous manner in the other half-mold 32. Furthermore, both half-molds 32, 34 may be formed with cooling channels (not shown) in close proximity to the cavity surfaces 42, 46.

The mode of operation is as follows: Substrate material is introduced via sprue 36 into the cavity of the mold 30 which is closed to compression-mold the substrate material to thereby form the substrate 40. In other words, the substrate material is injected into a slightly enlarged volume of the cavity in the mold 30. Then, as the clamping force is increased to move the half-molds 32, 34 of the mold 30 toward one another to the final cavity size, the injected material is compression-molded. The cavity surface 46 (and/or cavity surface 42) is hereby heated to assist the reproduction of the microstructure or nanostructure on the surface of the substrate 40. During production of the substrate 40, the feed channel 38 is sealed by the half-mold 34 so as to prevent thermoplastic material from migrating or escaping through the feed channel 38.

After the substrate 40 has cured, the half-mold 34 is slightly opened to form a cavity gap 50 as the substrate 40 disengages from the half-mold 34. Thereafter, cross-linking and curing coating material, e.g. polyurethane material, which in particular is optically highly transparent, is introduced into the cavity gap 50. During the subsequent compression molding step, the microstructure or nanostructure is again reproduced on the top layer formed by the coating material on the substrate 40. The heating unit 44 hereby assists to enhance accuracy of the reproduction, to improve the flow capability, and to promote cross-linkage. When the top layer has cured, the substrate has a highly transparent surface which is hard and scratch-resistant.

In the event, both sides of the finished product should be made scratch-resistant, it is, of course, possible to engulf both sides of the substrate with coating material. In this case, the mold and the process sequence need to be adapted accordingly.

In the afore-described embodiments, a single mold is used to produce the substrate and to produce a top layer on one or more sides of the substrate. It is, of course, also feasible, to carry out the substrate producing and inundating steps in different molds. In other words, the substrate can be made in a separate mold through an injection-molding or injection-compression molding process, and then transferred into a cavity of another mold, whereby the cavity of this mold is sized larger than the substrate to form the cavity gap, when the mold is closed, for realizing the subsequent inundating step.

Although not shown in detail, it is, of course, possible to add further components or materials, such as light guides, glass fibers or electronic components, to realize visual effects that render these components visible, in particular when the coating material and the substrate are transparent. For example, these components can be placed in the cavity gap upon the substrate before the substrate is inundated with the cross-linking, curing material. As a result, all structures of and on the substrate can be made visible.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of making an article with a microstructure or nanostructure, comprising the steps of:
using an injection molding process or an injection-compression molding process to produce a substrate with a microstructure or nanostructure applied upon a surface of the substrate; and
inundating the substrate with a cross-linking, curing material.

2. The method of claim 1, wherein the microstructure or nanostructure is compressed upon the surface of the substrate.

3. The method of claim 1, wherein the inundating step results in the formation of a top layer and includes the step of forming a surface of the top layer with a microstructure or nanostructure.

4. The method of claim 1, further comprising the step of forming a surface of the substrate other than the surface being inundated with a microstructure or nanostructure during or after the production of the substrate.

5. The method of claim 1, wherein the inundating step includes the steps of disposing the substrate in a mold cavity sized to form a cavity gap on the surface to be inundated, when the mold is closed, and filling the cavity gap with the cross-linking material.

6. The method of claim 5, wherein the substrate producing step includes the step of manufacturing the substrate in a separate mold cavity, and injecting plastic material into said mold cavity.

7. The method of claim 6, wherein at least one cavity surface of the mold cavities is constructed with a microstructure or nanostructure for reproduction.

8. The method of claim 7, further comprising the step of heating and/or cooling the at least one cavity surface.

9. The method of claim 1, wherein the cross-linking material is selected from the group consisting of polyurethane material, clear lacquer material, acrylic paint, and epoxy resin.

10. The method of claim 9, wherein the clear lacquer is UV curable clear lacquer.

11. The method of claim 1, wherein the substrate producing step or the inundating step includes a compression molding step.

12. The method of claim 1, wherein a substrate material for the substrate is optically transparent after curing, and the cross-linking material is optically transparent after cross-linking and curing.

13. The method of claim 1, wherein the substrate and cross-linking materials are highly transparent.

14. The method of claim 1, wherein the substrate is made of a substrate material, wherein after curing the substrate material has a refractive index which is different from a refractive index of the cross-linking and curing material.

15. The method of claim 1, wherein the inundating step includes the step of engulfing several surfaces with cross-linking, curing material.

16. The method of claim 5, further comprising the step of disposing a further component selected from the group consisting of light guide, optical fibers, and electronic component, in the cavity gap upon the surface of the substrate before the inundating step.

17. The method of claim 1, wherein the substrate producing and inundating steps are executed in a same cycle.

18. A method of making an article with a microstructure or nanostructure, comprising the steps of:
using an injection molding process or an injection-compression molding process for producing a substrate; and
inundating the substrate with a cross-linking, curing material to thereby form a surface of the substrate with a top layer having a microstructure or nanostructure.

19. The method of claim 18, further comprising the step of placing the substrate in a cavity for executing the inundating step.

20. The method of claim 18, further comprising the step of forming a surface of the substrate other than the surface being inundated with a microstructure or nanostructure during or after the substrate producing step.

21. The method of claim 18, wherein the inundating step includes the steps of disposing the substrate in a mold cavity sized to form a cavity gap on the surface to be inundated, when the mold is closed, and filling the cavity gap with the cross-linking material.

22. The method of claim 21, wherein the substrate producing step includes the step of manufacturing the substrate in a separate mold cavity, and injecting plastic material into said mold cavity.

23. The method of claim 22, wherein at least one cavity surface of the mold cavities is constructed with a microstructure or nanostructure for reproduction.

24. The method of claim 23, further comprising the step of heating and/or cooling the at least one cavity surface.

25. The method of claim 18, wherein the cross-linking material is selected from the group consisting of polyurethane material, clear lacquer material, acrylic paint, and epoxy resin.

26. The method of claim 25, wherein the clear lacquer is UV curable clear lacquer.

27. The method of claim 18, wherein the substrate producing step or the inundating step includes a compression molding step.

28. The method of claim 18, wherein a substrate material for the substrate is optically transparent after curing, and the cross-linking material is optically transparent after cross-linking and curing.

29. The method of claim 18, wherein the substrate and cross-linking materials are highly transparent.

30. The method of claim 18, wherein the substrate is made of a substrate material, wherein after curing the substrate material has a refractive index which is different from a refractive index of the cross-linking and curing material.

31. The method of claim 18, wherein the inundating step includes the step of engulfing several surfaces with cross-linking curing material.

32. The method of claim 18, wherein the substrate producing and inundating steps are executed in a same cycle.

33. The method of claim 21, further comprising the step of disposing a further component selected from the group consisting of light guide, optical fibers, and electronic component, in the cavity gap upon the surface of the substrate before the inundating step.

34. Apparatus for making an article with a microstructure or nanostructure, comprising:
a mold having a cavity for positioning a substrate, wherein the mold is constructed to form a cavity gap on at least one side of the substrate and has a cavity surface which is provided with a microstructure or nanostructure; and
a feeding device for introducing into the cavity gap a cross-linking material of low viscosity before curing to thereby allow formation of a top layer with reproduction of the microstructure or nanostructure.

35. The apparatus of claim 34, further comprising an injection device for introducing plastic material into the cavity of the mold for producing the substrate.

36. The apparatus of claim 34, further comprising a further mold having a cavity, and an injection device for introducing plastic material into the cavity of the further mold for producing the substrate.

37. The apparatus of claim 36, wherein the molds, the feeding device, and the injection device are disposed such that the introduction of the curing material and the introduction of the plastic material are executed in a same cycle.

38. The apparatus of claim 36, wherein the molds are arranged in a clamping unit selected from the group consisting of swivel platen clamping unit, sliding table clamping unit, or rotary table clamping unit.

39. The apparatus of claim 35, further comprising a clamping unit for receiving the mold such that the mold cavity is expanded after production of the substrate for realizing the cavity gap for subsequently inundating the substrate with the cross-linking material.

40. The apparatus of claim 34, further comprising a heating unit for heating the cavity surface.

41. The apparatus of claim 34, further comprising a clamping unit accommodating the first mold for executing an injection compression molding process.

42. The apparatus of claim 41, wherein the clamping unit is combined with a PUR-RIM machine for executing the injection compression molding process and a polyurethane RIM process.

43. The apparatus of claim 34, wherein the mold has formed therein cooling channels as part of a cooling system.

44. An injection mold for making an article with a microstructure or nanostructure, comprising two half-molds defining a cavity therebetween, one of the half-molds having an inside surface constructed with a microstructure or nanostructure, and the other one of the half-molds having a sprue for introduction of substrate material into the cavity, and a feed channel for introduction of coating material into a cavity gap, when the half-molds are moved apart, said mold being constructed such that the feed channel is sealed by the one of the half-molds, when substrate material is introduced to form the substrate.
